(19) United States
(12) Patent Application Publication
(10) Pub. No.: US 2008/0038695 A1
(43) Pub. Date: Feb. 14, 2008

(54) TREATMENT PROSTHESES FOR EDENTULOUS DENTAL PATIENTS

(76) Inventor: James E. Carlson, Alexandria, MN (US)

Correspondence Address: OPPENHEIMER WOLFF & DONNELLY LLP, 45 SOUTH SEVENTH STREET, SUITE 3300, MINNEAPOLIS, MN, 55402, US

(21) Appl. No.: 11/835,916

(22) Filed: Aug. 8, 2007

Related U.S. Application Data
(60) Provisional application No. 60/821,723, filed on Aug. 8, 2006.

(51) Int. Cl. A61C 13/00

(52) U.S. Cl. 433/213

(57) ABSTRACT

A treatment prosthesis is specifically designed to be efficiently fabricated without the use of bite rims or interocclusal records, thus resulting in a device that is beneficial in the development and training of patient tissues and muscular structures prior to the fitting of actual dentures. The treatment prosthesis, and the related method for fabrication, is efficiently designed using mathematical formulas and reference planes such that very little adjustment is necessary when incorporated into a patient's mouth. The treatment prosthesis includes several anterior teeth, thus providing some level of realism, while also including only occlusion rims on the posterior portions so that muscular development can be achieved without having to deal with natural interference created by typical cusp structures of molar teeth.

### RELATED APPLICATIONS

This application is related to Provisional Application Ser. No. 60/821,723, filed on Aug. 8, 2006, entitled TREATMENT PROSTHESES FOR EDENTULOUS DENTAL PATIENTS, which is relied upon for priority and which is incorporated herein in its entirety.

### BACKGROUND OF THE INVENTION

The present invention relates to a unique prosthetic device and method for fabricating a set of such prosthetic devices, which are used for evaluating and treating endentulous patients prior to the fabrication of new dentures. More specifically, the present invention relates to the creation of a treatment prosthesis which closely considers the functioning of facial and jaw bones/muscles, and efficiently produces a device which will allow muscular structures and tissues to be conditioned prior to fitting of actual dentures.

Various processes have been historically utilized to create dentures when individuals lose teeth. In one such approach, a bite registration is typically obtained, which captures the configuration and alignment of existing dental arches. More specifically, this bite registration, or interocclusal record, captures a positional relationship between the existing dental arches and provides a tool for use in the generation of further devices. As can be imagined, this bite registration is typically created by obtaining an interocclusal record of the existing dental arches prior to any reconstructive activities. Once obtained, the bite registration is then utilized as a guide for the creation of prosthetic devices, and eventually finished dentures.

One further method or step traditionally used in the fabrication of dentures requires the use of bite rims and/or wax rims. Bite rims traditionally are utilized to generate an occlusal surface on interium or final denture basis, for purposes of determining or making a maxillomandibular relation record. In addition, wax rims may be used as a tool to create denture teeth. The wax rim provides a formable component which is utilized in the fabrication and arrangement of teeth. Wax rims are typically utilized after a denture base is formed. In use, a wax rim is positioned/attached to the denture base, and can be formable to achieve a desired geometry. Dentists or technicians will use the combined denture base and wax rim to then carve or form teeth in a laboratory based on charts, pictures or measurements provided. For example, to allow easy access to those surfaces being worked on and to allow for the replication of expected jaw movements, the denture base and related wax rim may be attached to an alignment, articulation or mounting device of some type. The use of this alignment, articulation or mounting device, provides a mounting/holding structure, while also helping with desired alignments. From this point, further tooth formations and related adjustments can be made utilizing these reference planes.

As mentioned above, the use of bite rims may provide a starting point to establish appropriate reference planes when fabricating dentures. That said, the use of bite rims includes significant additional manipulation and unreferenced guesswork regarding the actual creation and formation of dentures, and typically requires an interocclusal record as a further reference. Once the bite rim is transformed into teeth, further creation is necessary to create a temporary or permanent denture, as a portion of the bite rim includes a formable/soft material (i.e. wax-like).

The natural configuration of teeth includes unique structures to provide the necessary chewing functions. These structures include tooth surfaces which have several cusps and related “flat” surfaces which interact with one another. These structures created a “meshing” of teeth, allowing for efficient chewing. This meshing is most obvious during occlusion of the posterior teeth. These tooth structures create challenges when designing and fitting dentures. More significantly, these meshing structures can interfere with the natural adjustments of the body to dentures (i.e. oral tissues, muscular structures, . . . ).

While the use of bite registrations and bite rims is certainly sufficient and provides one effective methodology for development of dentures, it is time consuming and can be somewhat tedious. Consequently, any steps to more efficiently fabricate prosthetic devices, especially treatment prostheses which provide temporary tools for evaluation and treatment prior to the fabrication of dentures themselves is a very beneficial activity.

### BRIEF SUMMARY OF THE INVENTION

The present invention provides a method and system for the fabrication of treatment prostheses which is efficient and typically immediately accurate. Due to the accuracy of the initially generated treatment prostheses, the need for revisions and modifications is virtually eliminated. The present process and system does not require the use of interocclusal records (bite registration), thus creating further time efficiency. Additionally, bite rims are no longer required as part of the fabrication process.

Utilizing an articulation device, such as the Accu-Liner® articulator developed and distributed by Accu-Liner Products of Woodinville, Wash., along with appropriate mathematically formulas and related reference planes of the skull, the process and system of the present invention provides for the calculated creation of treatment prostheses. Further information regarding the Accu-Liner® device, and the use of the Accu-Liner® device in denture fabrication can be found in the manual entitled “The AccuLiner System”, distributed by Accu-Liner Products, and incorporated herein by reference The process does begin with impressions of the patient's dental arches, thus does provide for appropriate “customization” necessary for a particular patient. From that point, known measurements and occlusal relationships are utilized to fabricate the treatment prostheses. By utilizing such techniques, the need for the bite registration process is effectively eliminated. Further, because the process is based on well known information and related mathematical formulas, the resulting device will function appropriately without the need for considerable modification or adjustment.

In summary, the fabrication process begins with impressions of the patient's dental arches. Specifically, the maxillary and mandibular dental arches are exposed to appropriate molds and models or casts created using model stone. Once the stone models are created, the maxillary stone model is mounted to an articulator, for appropriate alignment. The articulating device is then adjusted so that this alignment is achieved with relation to the maxillary stone model. Next, the mandibular stone model is similarly mounted to the articulating device. Again, the mandibular stone model is appropriately aligned, utilizing adjustments available on the articulating device. At this point, the alignment adjustments of the articulating device are captured, and stored for future use. Next, an occlusal template is fabricated. This occlusal template is more specifically fabricated utilizing an occlusal scale, which has been previously developed to plot various points of an appropriate occlusal template. The occlusal scale is a tool utilized to determine and plot an outline of the occlusal pattern. Creating the occlusal template begins with the location of an “F point” based on measurements previously obtained. Based on known mathematically formulas, the anticipated locations of the various cuspid points are further determined. Additionally, the appropriate arch width of the cuspid points is also determined utilizing mathematical formulas, thus allowing the outline of an upper prosthesis to be drawn.

Next, the upper and lower denture bases are fabricated. Generally speaking, the bases simply fit over the ridges of the maxillary and mandibular stone models and extend outwardly a desired distance.

After this previous step, the anterior occlusal vertical dimension of the models is set. Utilizing known dimensions and relationships, the vertical dimension is set at or close to 38 mm. The known relationships between the maxillary model and the mandibular model, along with dimensions to the anticipated occlusal surface, is utilized to set the overall vertical dimension as desired. Naturally, this dimension is precisely “settable” utilizing the above referenced articulation device.

Once this appropriate position is set within the articulating device, fabrication of the upper treatment prosthesis can begin. As mentioned above, the known position of the occlusal surface can be used, in conjunction with the positioned denture base, thus allowing the positioning of six anterior teeth on the denture base. In conjunction with the above referenced occlusal template, the remaining portion of the upper treatment prosthesis is generated using an occlusion rim which extends posteriorly from the above mentioned anterior teeth. In each case, the edge of each tooth will contact the occlusal template referenced above. Further, the occlusion rims will contact the appropriate outline of the occlusal template.

Utilizing a similar process, the lower treatment prosthesis can now be fabricated. To carry out this process, the model and denture base for the mandibular model is attached to the alignment device. Based on this attachement, the occlusal surface or plane is now known. Using this plane, the six anterior denture teeth may now be positioned on mandibular denture base with the incisal edges contacting the top of the mounting table. Utilizing this, the lower occlusion rim can similarly be positioned on the denture base. The mandibular model is then removed.

Next, the articulation device is again adjusted to appropriately house both the maxillary and mandibular model. Utilizing the operation and movements of the articulator, the treatment prostheses are then checked for appropriate alignment and cooperation of the various prostheses elements. At this point, the treatment prostheses are complete. It is noted again that this process does not utilize bite registrations or bite rims as previously required. Further, the finished result provides a pair of prosthetic devices (i.e. an upper prosthesis and a lower prosthesis) which articulate and cooperate in a patient's mouth in the same manner as they do when placed in the articulating device.

Generally speaking, it is an object of the present invention to provide treatment prostheses which can be easily and efficiently fabricated. The treatment prosthesis is designed to allow for the conditioning of tissues and muscular structures prior to the fitting of final dentures. Further, it is an object to provide treatment prostheses that will be easily fit to the patient, without the need for continued adjustment and modification. Additionally, it is an object of the present invention to provide a design for the treatment prostheses, and a method for their creation, that does not require the use of bite registrations or typical bite rims.

### BRIEF DESCRIPTION OF THE DRAWINGS

Further objects and advantages of the present invention will be seen by referring to the attached drawings in which:

FIG. 1 is a schematic diagram of a treatment prostheses of the present invention;

FIG. 2 is a schematic diagram of the articulating device showing the treatment prosthetic attached thereto;

FIG. 3 is a flow chart outlining the overall process for fabricating the treatment prostheses;

FIG. 4 is an illustration showing an occlusal template used in creating the treatment prostheses;

FIG. 5 is a side view showing the step of aligning the maxillary arch with a reference plane using an articulating device; and

FIG. 6 is an illustration showing the step of aligning the anterior denture teeth and the occlusion rim with the reference plane.

### DETAILED DESCRIPTION OF THE PREFERRED EMBODIMENTS

As mentioned above, the present invention provides treatment prostheses for use in treating patients prior to the fitting of completed dentures. This appliance will provide a tool for professionals to use while working with patients to condition tissues and muscular structures prior to the fitting of final dentures. Using the treatment prostheses insures the patient will be successful in adapting to the final dentures when employed. As discussed below, the process and systems of the present invention efficiently utilize time and help to produce a final denture that will likely function without issues. Most significantly, the treatment prostheses are created without requiring bite registrations.

In use, the treatment prostheses are used to aid the dentist in treating the muscles, mucosa, and temporomandibular joints of edentulous or partially edentulous dental patients prior to fabricating their new dentures. The treatment prostheses include occlusion rims that help to establish an occlusion plane, without adding the interference of interlocking cusps and valleys that will ultimately exist in finished dentures. Most significantly, the prostheses include an accurate predetermined occlusal vertical dimension along with an accurate predetermined relationship of the upper and lower occlusal surface.

Generally speaking, the treatment prostheses are dental devices that are placed over the ridges of a complete or partially edentulous patient. The treatment prostheses are fabricated using plastic (resin) bases and occlusion rims. The base is typically pink in color, while the occlusion rim is tinted tooth color. In addition, the treatment prostheses are usually fabricated with anterior denture teeth, thus adding further reality to the actual device.

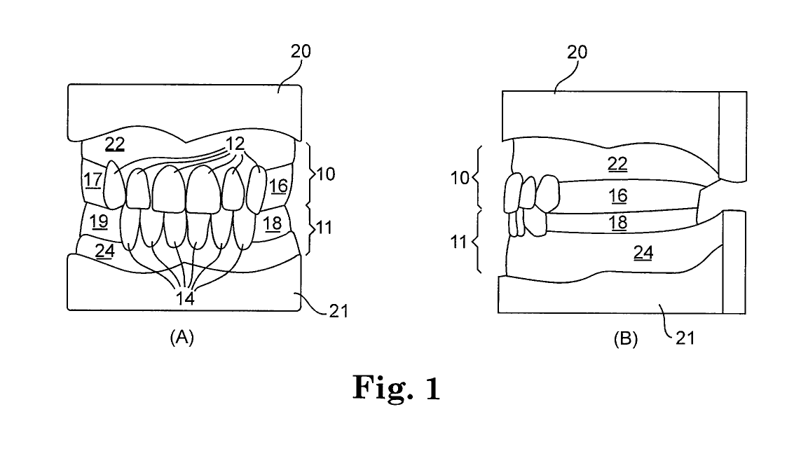

Referring now to FIG. 1 there is shown one embodiment of the treatment prostheses of the present invention, including an upper treatment prosthesis 10 and a lower treatment prosthesis 11. Obviously, FIG. 1 illustrates a front view (A) and a side view (B). In this particular case, treatment prosthesis 10 is attached to an upper mounting structure 20 while lower treatment prosthesis 11 is attached to a lower mounting structure 21, the advantages of which are further outlined below. As can also be seen, upper treatment prosthesis 10 includes six upper anterior teeth 12 along with a pair of upper occlusion rims 16 and 17. Similarly, lower treatment prosthesis 11 includes six lower anterior teeth 14, along with a corresponding pair of lower occlusion rims 18 and 19. Upper treatment prosthesis 10 and lower treatment prosthesis 11 are shown in FIG. 1 in a closed/contacting relationship. It is understood however that upper treatment prosthesis 10 and lower treatment prosthesis 11 are designed to clearly interact with one another, however are independent components which are not connected to one another. In addition to the components outlined above, the upper treatment prosthesis 10 further includes an upper denture base 22 and lower treatment prosthesis 11 includes a lower denture base 24. Upper denture base 22 is designed to closely fit over the maxillary or upper dental arch within the patient's mouth. Similarly, a lower denture base 24 is designed to closely fit over the lower or mandibular dental arch of the patient.

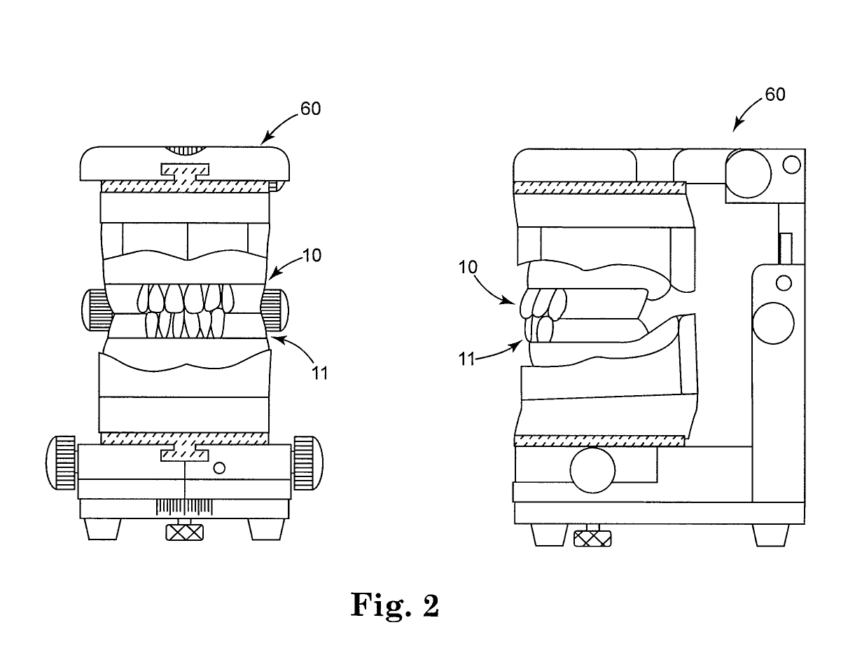

Referring now to FIG. 2, upper treatment prosthesis 10 and lower treatment prosthesis 11 are shown as attached to an articulating device 60. In this particular case, the articulating device generally illustrated is an Accu-Liner® articulator developed distributed by Accu-Liner Products of Woodinville, Wash. As is well known by those familiar with this product, the Accu-Liner® articulation device provides a realistic and accurate fixture to replicate movements of the human jaw. As such, this device is very helpful in the development and design of dentures and related products (e.g. partial dentures, implants, etc.) Most significantly, the Accu-Liner® articulation device allows for infinite alignment adjustments, thus allowing dental professionals to appropriate replicate the configuration operation of a patient's teeth. Further information regarding the Accu-Liner® articulator can be found in the above referenced publication entitled “The AccuLiner System”.

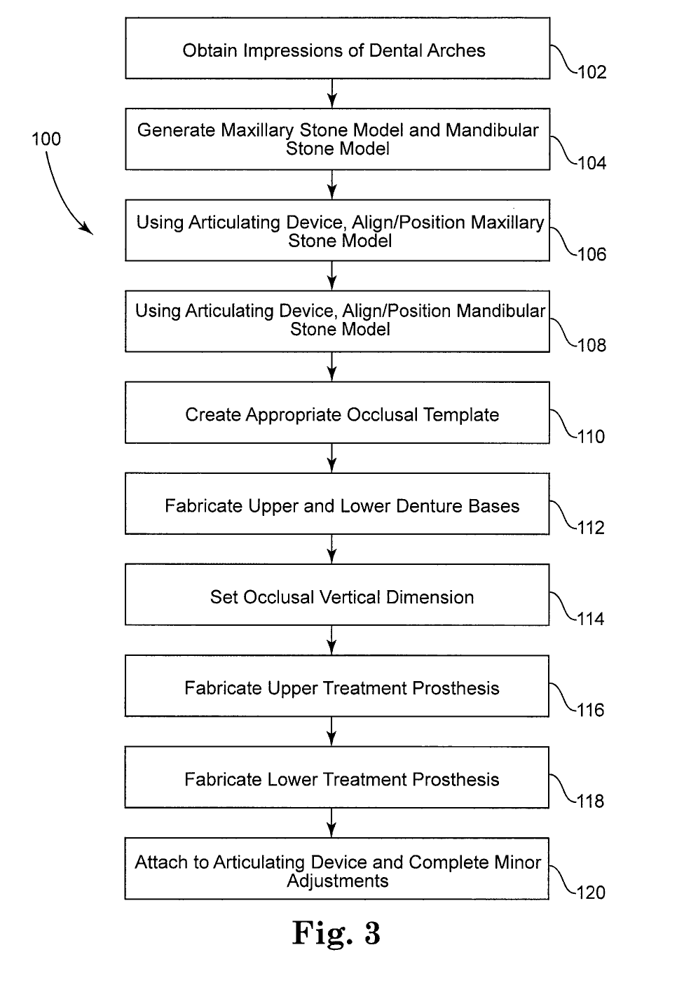

Referring now to FIG. 3, the fabrication process 100 for creating the treatment prostheses is shown in a flowchart format. As illustrated, fabrication process 100 begins with a dental technician obtaining impressions of the maxillary and mandibular dental arches of the patient at step 102. (Naturally, these impressions could be obtained by anyone on the dental staff that is appropriately trained. Typically however, this is a dental technician performing this task.) Using the impressions of the patient's dental arches, a maxillary stone model and a mandibular stone model are generated at step 104. As is well understood, these stone models are created by pouring of model stone into the respective impressions.

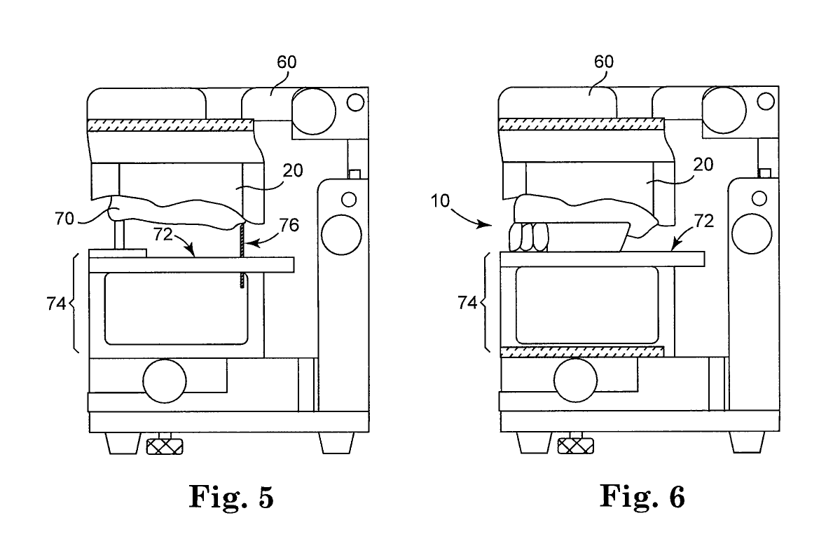

To continue the fabrication process, at step 106 the maxillary stone model is mounted to an articulating device for reference alignment and positioning. Most significantly, this step achieves the alignment of the maxillary stone model to a mounting table portion of the articulator. Referring to FIG. 5 this step is generally illustrated, wherein the articulating device 60 is shown with an exemplary maxillary stone model 70 attached to the upper mounting structure 20. Using these attachments, the HIP plane of the maxillary model 70 is aligned to be parallel with the top surface 72 of the mounting table 74. In addition, a mounting fence 76 used to position the hamular notches anteroposteriorly by inserting into either the front or rear slot depending on the size of the model. Once aligned, the settings of articulator 60 are maintained or saved, and the maxillary stone model 70 is removed.

Referring again to FIG. 3, step 108 next involves the similar alignment of the mandibular stone model, as is likely anticipated by those skilled in the art. Here the mandibular model is uniquely aligned to the mounting table by positioning the labial sulcus 19 millimeters above the top of the mounting table. Additionally, points on top of the retromolar pads of the model are positioned to contact the top of the mounting table while points of the retromolar pads are aligned over the same slot that was used to mount the maxillary model. At this point, the settings of the articulating device are saved/recorded and the mandibular stone model is removed.

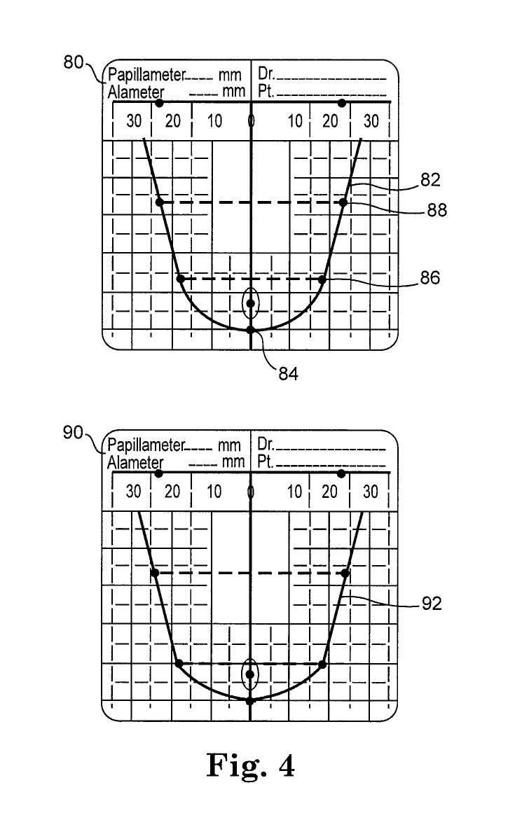

At this point, the next step of the process involves the generation of an appropriate occlusal template for use in further alignment tasks as the treatment prostheses is created. This occlusal template is based upon discoveries of Mr. Karl-Heinz Staub and is well understood by those skilled in the art. For reference, two exemplary occlusal templates are shown in FIG. 4. More specifically, FIG. 4 illustrates a first occlusal scale 80 and a second occlusal scale 90, each having slightly different templates drawn thereon. For reference, the development of the first occlusal template 82, shown on first occlusal scale 80, will be discussed in detail, with the understanding that a second occlusal template 92 is generated in a similar manner. Each relevant occlusal template is generated by first plotting the “F” point 84. The anteroposterior position is determined by known mathematical formula. Next, the anteroposterior position of the cuspid points 86 is determined, again using mathematical formula. The next plot points are the mediolateral position of the cuspid points 88 which are determined based on the ala-to-ala width of the nose measurement. At this point, the template 82 can be drawn on the occlusal scale 80.

As mentioned, FIG. 4 illustrates two different occlusal templates. Second occlusal template 92 is slightly wider than first occlusal template 82. This simply illustrates that adjustments in the occlusal template may be necessary based on the particular patient involved. For more information on the generation of occlusal templates, reference is made to the above listed manual entitled “The AccuLiner System.”

Referring again to FIG. 3, the next step in the process involves the creation of upper and lower denture bases. Specifically, step 112 involves the creation of these bases using well know techniques. Specifically, the base is fabricated by molding an appropriate resin over the ridges of the maxillary and mandibular stone models. Next, the border of the flanges is established as 2 millimeters occlusal to the depth of the sulci.

To prepare for further fabrication steps, the process 100 next moves to step 114 where the anterior vertical occlusal dimension of the maxillary and mandibular models is set at or close to 38 millimeters. To establish these dimensions, the settings of the articulating device are adjusted as necessary. The occlusal distance is measured from the depth of labial sulcus of the maxilla to the depth of the labial sulcus of the mandible. Base upon this known setting, the distance from the depth of the labial sulcus of the maxillary model to the occlusal surface is set to 21 millimeters. Similarly, the distance from the depth of the labial sulcus of the mandibular model to the occlusal surface is set to 17 millimeters.

Now that all the appropriate settings are achieved, fabrication of the upper treatment prosthesis 10 is started at step 116. This step starts by positioning the maxillary model with it's denture base into the articulating device. Next the occlusal surface is established, which is parallel to the top of the mounting table and is 21 millimeters below the depth of the labial sulcus (consistent with the above set dimension). Utilizing this established occlusal surface, and the previously generated occlusal template, six (6) anterior denture teeth can be set upon the denture base. The mesial incisal edge of the central incisors is to be aligned over the “F” Point of the occlusal template. In addition, the incisal edges of all the teeth contact the occlusal template. For the remaining portion of the upper treatment prostheses, occlusion rims extend posterior from the initial six (6) anterior denture teeth and generally follows the occlusal template. Following the formation of the occlusion rims, the upper treatment prosthesis 10 is substantially complete as illustrated in FIG. 6. At this point the upper treatment prosthesis 10 is removed from the articulation device.

Next, at step 118 the lower treatment prosthesis 11 is fabricated. To start this step, the mandibular model with its denture base is inserted into the articulating device. The occlusal surface is established parallel to the top of the previously aligned mounting table, and is positioned 17 millimeters above the depth of the labial sulcus. At this point, the first six (6) anterior denture teeth can be set upon the denture base. The incisal edges of all teeth will contact the mounting table. Further, the occlusion rims are placed posterior from the initial six (6) anterior denture teeth of the lower treatment prostheses. At this point the lower treatment prosthesis 11 is complete.

Lastly, at step 120 the maxillary model and finished upper treatment prosthesis 10 is reinserted into the upper member of the articulating device. Similarly, the mandibular model and finished lower treatment prosthesis 11 is inserted into the lower member of the articulating device. Any necessary final adjustments can be completed at this point. That said, due to the manner in which the treatment prostheses was fabricated, very few adjustments (if any) will be necessary. When the occlusal surfaces of the two opposing treatment prostheses come together in the articulator they fully contact each other. What is more remarkable is that when the devices are inserted into a patient's mouth the opposing occlusal surfaces also fully contact. Additionally, this feat is accomplished without the benefit of taking an interocclusal record on the patient prior to fabricating the prostheses.

As discussed in detail, the above outlined method is used for the creation of treatment prostheses which includes a combination of occlusion rims and anterior denture teeth. The same method may be used to create maxillary and mandibular bite rim used for the eventual creation of maxillary and mandibular dentures. In this case, the bite rim would include only a denture base and a related continuous wax rim structure that simply follows the determined occlusal pattern previously developed. Such a continuous bite rim would be substantially similar to the occlusion rim illustrated above, but simply not including the anterior denture teeth. The bite rims would be aligned with the occlusal plane and have the same anterior vertical dimensions outlined above. Thus, the generated bite rims would provide a starting point for denture development that is more efficient and accurate.

The present invention is described above in reference to the drawings and certain embodiments. Foregoing detailed description and examples have been given for clarity of understanding the invention. Those skilled in the art will recognize that many changes can be made to the described embodiments without departing from the scope and spirit of the invention. Thus, the scope of the present invention should not be limited to the exact details and structures described herein, but rather the appended claims and equivalents thereof.

What is claimed is:

1. A treatment prosthesis for use in conditioning tissues and muscular structures prior to the fitting of dentures, comprising:
a denture base configured to have a mating surface which will closely fit a dental arch of an edentulous patient;
a plurality of anterior denture teeth aligned with the dental arch of the patient, each of the plurality of the anterior denture teeth being a predetermined alignment distance from a pre-established occlusal plane; and
at least one occlusion rim extending posterior from the plurality of anterior denture teeth, the occlusion rim having an occlusal surface aligned with the pre-established occlusal plane.

2. The treatment prosthesis of claim 1 wherein the denture base, anterior denture teeth, and occlusion rim are sized so that the distance from an inner most portion of the mating surface of the denture base to the surface of the occlusion rim is a predetermined height distance.

3. The treatment prosthesis of claim 2 wherein the denture base is configured to closely fit an upper dental arch of the patient and the predetermined height distance is in a range between 20 millimeters and 22 millimeters.

4. The treatment prosthesis of claim 2 wherein the denture base is configured to closely fit a lower dental arch of the patient and the predetermined height distance is in a range between 16 millimeters and 18 millimeters.

5. The treatment prosthesis of claim 1 wherein the plurality of anterior denture teeth include six anterior denture teeth.

6. The treatment prosthesis of claim 1 wherein the denture base will include a portion of the mating surface which corresponds to an HIP plane of the patent's dental arch, and wherein the portion of the mating surface corresponding to the HIP plane is substantially parallel to the pre-established occlusal plane.

7. Treatment prostheses for edentulous patients which provides for the conditioning of tissues and muscular structures of a patient prior to the fitting of dentures, comprising:
An upper treatment prosthesis configured to closely fit over an upper dental arch of the patient, the upper treatment prosthesis comprising a upper denture base, a plurality of upper anterior teeth attached to a lower portion of the upper denture base and an upper occlusion rim attached to the lower portion of the upper denture base and positioned posterior to the plurality of anterior teeth; and
A lower treatment prosthesis configured to closely fit over a lower dental arch of the patient, the lower treatment prosthesis comprising a lower denture base, a plurality of lower anterior teeth attached to an upper portion of the lower denture base and a lower occlusion rim attached to the upper portion of the lower denture base and positioned posterior to the plurality of anterior teeth;
Wherein lower surface of the upper occlusion rim and an upper surface of the lower occlusion rim are generally planar and exist in a pre-established occlusion plane, the pre-established occlusion plane being parallel with, and a predetermined distance from, an upper alignment plane formed by the points on the upper denture base configured to fit adjacent to the HIP plane of the patient's upper dental arch, the pre-establish occlusion plane also parallel with, and a predetermined distance from, a lower alignment plane formed by the portions of the lower dental base designed to fit adjacent to the HIP plane of the patient's lower dental arch.

8. The treatment prostheses of claim 7 wherein the upper occlusion rim comprises a right side upper occlusion rim and a left side upper occlusion rim, with the right side upper occlusion rim position adjacent and posterior to a right-most tooth of the anterior upper teeth, and the left side upper occlusion rim positioned adjacent and posterior to a left-most tooth of the anterior upper teeth.

9. The treatment prostheses of claim 7 wherein the lower occlusion rim comprises a right side lower occlusion rim and a left side lower occlusion rim, with the right side lower occlusion rim position adjacent and posterior to a right-most tooth of the anterior lower teeth, and the left side lower occlusion rim positioned adjacent and posterior to a left-most tooth of the anterior lower teeth.

10. The treatment prostheses of claim 7 wherein the upper occlusion rim comprises a right side upper occlusion rim and a left side upper occlusion rim, with the right side upper occlusion rim position adjacent and posterior to a right-most tooth of the anterior upper teeth, and the left side upper occlusion rim positioned adjacent and posterior to a left-most tooth of the anterior upper teeth, and wherein the lower occlusion rim comprises a right side lower occlusion rim and a left side lower occlusion rim, with the right side lower occlusion rim position adjacent and posterior to a right-most tooth of the anterior lower teeth, and the left side lower occlusion rim positioned adjacent and posterior to a left-most tooth of the anterior lower teeth.

11. The treatment prosthesis of claim 7 wherein the predetermined distance between the pre-established occlusion plane and the upper alignment plane is in a range between 20 millimeters and 22 millimeters.

12. The treatment prosthesis of claim 7 wherein the predetermined distance between the pre-established occlusion plane and the lower alignment plane is in a range between 16 millimeters and 18 millimeters.

13. A method for creating a treatment prosthesis for use in conditioning the tissue and muscular structure of a patient prior, comprising:
generating an upper dental arch model and a lower dental arch model which substantially replicate an upper and a lower dental arch of the patient;
aligning the upper dental arch model and the lower dental arch model with a defined occlusion plane;
creating an upper denture base and a lower denture base, the upper denture base and the lower denture base configured to closely fit over the upper dental arch model and the lower dental arch model, respectively, attaching the upper denture base to the aligned upper dental arch model and attaching the lower denture base to the aligned lower dental arch model;
attaching a plurality of anterior upper denture teeth to the upper denture base such that the cusps of the anterior upper denture teeth are closely aligned with the defined occlusion plane;
attaching upper occlusion rims to a posterior portion of the denture base with the upper occlusion rims having an occlusion surface aligned with the occlusion plane;
attaching a plurality of anterior lower denture teeth to the lower denture base such that the cusps of the anterior lower denture teeth are closely aligned with the defined occlusion plane; and
attaching lower occlusion rims to a posterior portion of the lower denture base with the lower occlusion rims having an occlusion surface aligned with the occlusion plane;
wherein the occlusion surfaces of the upper occlusion rim and the lower occlusion rim will be in generally planar contact with one another when place in the patient due to the alignment of the upper and lower dental arch models.

14. The method of claim 13 wherein the alignment of the upper dental arch model and the lower dental arch model is achieved by attachment to an articulating device and adjusting the articulating device to achieve the necessary alignment with a reference planar surface which is part of the articulating device.

15. The method of claim 14 wherein the articulating device is an Accu-Liner® articulating device.

16. The method of claim 14 wherein the step of alignment further involves positioning the upper and lower dental arch models predetermined distances from the defined occlusion plane.
